(19) United States
(12) Patent Application Publication
(10) Pub. No.: US 2008/0261797 A1
(43) Pub. Date: Oct. 23, 2008

(54) Optical glass for press molding and optical element

(75) Inventors: Takashi Tsutsumi, Osaka (JP); Risa Suzuki, Osaka (JP)

Correspondence Address: BIRCH STEWART KOLASCH & BIRCH, PO BOX 747, FALLS CHURCH, VA, 22040-0747, US

(73) Assignee: OMG. CO., LTD.

(21) Appl. No.: 12/003,569

(22) Filed: Dec. 28, 2007

(30) Foreign Application Priority Data
Jan. 11, 2007 (JP) 2007-003809

(51) Int. Cl. C03C 3/068; C03C 3/089; C03C 3/064; C03C 3/091

(52) U.S. Cl. 501/66; 501/65; 501/77; 501/78

(57) ABSTRACT

The optical glass for press molding of the present invention contains 35 to 45% by weight of SiO₂, 15 to 30% by weight of B₂O₃, and 18 to 33% by weight of CaO so that the total amount is 75 to 96% by weight. Also, the glass has an index of refraction (nd) of 1.55 to 1.63, an optical constant value ranging from 55 to 63 by the Abbe number (νd), a specific gravity of not more than 2.75, and a glass transition temperature (Tg) of not more than 550° C. According to the present invention, it is possible to provide inexpensive optical glass for press molding which exerts intended optical performance while realizing further reduction in size and weight of optical devices.

### BACKGROUND OF THE INVENTION

1. Field of the Invention

The present invention relates to optical glass for press molding which exerts intended optical characteristics, realizes further reduction in size and weight of optical devices, and is low in cost, and to an optical element formed of such optical glass.

2. Description of the Prior Art

In a manufacturing process of optical glass by fine press molding, a heated glass preform material is press-molded by a die having a finely finished surface shape, to form an intended glass shape such as a lens. In such a press molding method, since a glass preform material that is heated to a softened state is press-molded by a die at a high temperature, oxidation and deterioration of the die, and deterioration in accuracy of a die molding face may occur as a result of repeated production of optical glass.

Therefore, optical glass having a low glass transition temperature (Tg) is requested to prevent damages on the die during press molding, and to keep high accuracy of a molding face of the die for a long term, and to enable fine press molding at a lower temperature.

For meeting this request, various proposals have been made (Patent documents 1 to 3).

[Patent document 1] Japanese Unexamined Patent Publication No. 2004-175592

[Patent document 2] Japanese Unexamined Patent Publication No. 2005-306627

[Patent document 3] Japanese Unexamined Patent Publication No. 2006-306635

Patent document 1 proposes optical glass based on SiO₂—B₂O₃—BaO—Y₂O₃—Li₂O—RO having a glass transition temperature ranging from 420 to 580° C. Patent document 2 proposes optical glass based on SiO₂—B₂O₃—Al₂O₃—Li2O—RO having a glass transition temperature of not more than 480° C. Patent document 3 proposes optical glass based on SiO₂—B₂O₃—SrO—Li₂O having a glass transition temperature of not more than 520° C.

However, all of these inventions have some problems, and further improvements are required. For example, in the invention of Patent document 1, the relatively large content of Y₂O₃ (1 to 10% by weight) is primarily problematic. To be more specific, the Y₂O₃ component has a drawback of deteriorating fusibility, although it advantageously improves an index of refraction of glass. The Y₂O₃ component is also problematic in that not only the fusion temperature is increased but also devitrification resistance is deteriorated. Optical glass disclosed in Patent document 1 is also problematic in that water resistance (chemical durability) is impaired, and the specific gravity is increased because of the large content of BaO (2 to 9% by weight).

On the other hand, optical glass disclosed in Patent document 2 is problematic in that the content of Li₂O is large (12.5 to 25% by weight), although it realizes a low specific gravity and a low glass transition temperature. In other words, although the Li₂O component is effective for lowering the softening temperature of glass, it has a drawback that it is expensive because it is a rare material, and additionally it significantly deteriorates chemical durability. In the invention of Patent document 2, it appears that the content of Al₂O₃ is large (4 to 15% by weight), however, the Al₂O₃ component disadvantageously causes a rise in the softening temperature, whereas it improves the durability of glass.

Optical glass disclosed in Patent document 3 is almost the same with the invention of Patent document 2, and has a principal problem of a large content of Li₂O (12 to 20% by weight). Further, in this invention, since the content of SrO as an essential component is large (10 to 25% by weight), the specific gravity of glass tends to increase.

In principle, in optical devices for which lower cost, and reduction in size and weight are requested as is a digital camera incorporated into a mobile phone set, inexpensive optical glass for press molding that is low in specific gravity, and excellent in chemical durability, and exerts intended optical performance, while having a low glass transition temperature is strongly demanded.

The present invention was devised in consideration of the above demand, and it is an object of the invention to provide optical glass for press molding which is low in cost and realizes further reduction in size and weight of optical devices while exerting intended optical performance. It is also an object of the present invention to provide an optical element such as a glass lens formed of such optical glass for press molding.

### SUMMARY OF THE INVENTION

As a result of diligent efforts for achieving the above object, the present inventors found that optical glass having an index of refraction (nd) of 1.55 to 1.63, an Abbe number (νd) of 55 to 63, a specific gravity of not more than 2.75, a glass transition temperature (Tg) of not more than 550° C. is realized by containing SiO₂, B₂O₃ and CaO in a specific ratio even when contents of Li₂O, Al₂O₃, Y₂O₃, BaO and the like are controlled, and accomplished the present invention.

To be more specific, the present invention provides optical glass for press molding which contains 35 to 45% by weight of SiO₂, 15 to 30% by weight of B₂O₃, and 18 to 33% by weight of CaO so that the total amount is 75 to 96% by weight, and has an index of refraction (nd) of 1.55 to 1.63, an optical constant value ranging from 55 to 63 by the Abbe number (νd), a specific gravity of not more than 2.75, and a glass transition temperature (Tg) of not more than 550° C. The present invention also provides an optical element such as a glass lens formed of the above optical glass.

Preferably, the optical glass according to the present invention further contains 0 to 2.0% by weight of BaO, 0 to 1.0% by weight of Y₂O₃, 0 to 8.0% by weight of Na₂O, 0 to 8.0% by weight of K₂O, 4.0 to 7.5% by weight of Li₂O, 0 to 3.0% by weight of Al₂O₃, 0 to 1.0% by weight of Sb₂O₃, and 0 to 5.0% by weight of Nb₂O₅, and the total amount of Na₂O, K₂O and Li₂O should be not more than 18% by weight. Any of the above ranges of value includes numerical values of both ends including the cases of SiO₂, B₂O₃ and CaO.

Preferably, the present invention substantially excludes glass components other than SiO₂, B₂O₃, CaO, BaO, Y₂O₃, Na₂O, K₂O, Li₂O, Al₂O₃, Sb₂O₃, and Nb₂O₅. Therefore, in a preferred embodiment of optical glass, at least either one of BaO, Y₂O₃, Na₂O, K₂O, Li₂O, Al₂O₃, Sb₂O_{3,} and Nb₂O₅ is contained in a total amount of 4 to 25% by weight.

In any case, SiO₂ is a component which is to become backbone of glass, and an SiO₂ content of not more than 35% by weight will deteriorate the durability. On the other hand, when the content exceeds 45% by weight, the viscosity increases and fusibility decreases. For this reason, in the present invention, the content is set in the range of 35 to 45% by weight. More preferably, the content is more than 35% by weight and not more than 45% by weight, and most preferably, 36 to 44% by weight.

B₂O₃ improves fusibility and hence enables fusion of a glass material at a low temperature. However, when the content of B₂O₃ is less than 15% by weight, the glass is more susceptible to devitrification. In order to achieve the intended Abbe number (νd), in the present invention, the content of B₂O₃ is set preferably 15 to 30% by weight, and most preferably 16 to 25% by weight.

CaO is a component that improves the index of refraction of glass, improves chemical durability, and improves fusibility because of its low viscosity at a high temperature. In the present invention, from the relationship between 35 to 45% by weight of SiO₂ and 15 to 30% by weight of B₂O₃, the content of CaO is 18 to 33% by weight (more preferably 19 to 32% by weight), and a total amount of SiO₂, B₂O₃ and CaO is 75 to 96% by weight (more preferably 78 to 94% by weight). In the present invention, by this specific combination of numerical values, the properties of an index of refraction (nd) of 1.55 to 1.63, an Abbe number (νd) of 55 to 63, a specific gravity of not more than 2.75, and a glass transition temperature (Tg) of not more than 550° C. are realized.

Although Li₂O is effective for lowering the softening temperature of glass, it is expensive and significantly deteriorates chemical durability. By limiting the content of Li₂O to not more than 7% by weight, chemical durability of glass is ensured. Preferably, the content is 4.0 to 7.5% by weight, and more preferably 5.0 to 7.0% by weight.

The components Na₂O, K₂O and Li₂O are effective for lowering the softening temperature, however, when the total amount exceeds 18% by weight, devitrification resistance and chemical durability are deteriorated. Therefore, the total amount is preferably not more than 18% by weight, and most preferably 5.9 to 17.5% by weight. Na₂O is used in the range of 0 to 8% by weight, K₂O is used in the range of 0 to 8% by weight, and Li₂O is used in the range of 4.5 to 7.5% by weight.

BaO is effective for improving the index of refraction of glass, however, it deteriorates chemical durability and increase the specific gravity as the adding amount increases. Therefore, it is added preferably in an amount of not more than 2.0% by weight, and more preferably in an amount of less than 2.0% by weight.

Y₂O₃ is effective for improving the index of refraction, and by setting the content of Y₂O₃ preferably at not more than 1.0% by weight, and more preferably at less than 1.0% by weight, devitrification resistance is improved.

Al₂O₃ is effective for improving durability of glass, however, too much amount will deteriorate devitrification resistance. Therefore, for keeping excellent devitrification resistance and chemical durability, the content is preferably 0 to 3.0% by weight.

Sb₂O₃ may be added for the purpose of deforming. However, in this case, it should be used within the range of 0 to 1.0% by weight, and no further deforming effect is expected by addition of more amount.

The optical glass of the present invention has a specific gravity of not more than 2.75, and a glass transition temperature of not more than 550° C., and typically has a specific gravity of 2.65 to 2.75, and a glass transition temperature of about 450 to 550° C.

According to the aforementioned present invention, it is possible to realize inexpensive optical glass for press molding and an optical element such as a glass lens, which exert intended optical performance while realizing further reduction in size and weight of optical devices.

### DETAILED DESCRIPTION OF THE INVENTION

In the following, the present invention will be explained in more detail based on examples, however, the concrete description will not limit the present invention in any way.

Optical glass according to Examples 1 to 10 is obtained by formulating raw materials for glass such as a metal oxide, carbonate, and nitrate, fusing and defoaming the formulated raw materials for glass at a temperature between 1300 and 1400° C. in a fusion container such as a platinum crucible, followed by homogenization by stirring, and pouring the resulting product into a mold and slow cooling. Compositions of the obtained optical glass are as shown in Table 1.

For optical glass of each example, the index of refraction nd, Abbe number νd, specific gravity, and glass transition temperature (° C.) were measured. The index of refraction (nd) and Abbe number (νd) were measured by using a refractometer (KPR-200, manufactured by Kalnew Optical Industry Company). The specific gravity was determined according to the method described in Japan Optical Glass Industrial Standard JOGIS 05-1975 (a measurement method of the specific gravity of optical glass). The glass transition temperature (Tg) was measured at a temperature rising speed of 5° C./min. using a differential thermal dilatometer.

TABLE 1

| | | Examples | Examples | Examples | Examples | Examples | Examples | Examples | Examples | Examples | Examples |
|---|---|---|---|---|---|---|---|---|---|---|---|
| | | 1 | 2 | 3 | 4 | 5 | 6 | 7 | 8 | 9 | 10 |
| Compositions | SiO2 | 39.0 | 39.0 | 37.0 | 40.0 | 41.0 | 42.0 | 38.0 | 44.0 | 43.0 | 36.0 |
| of the glass | B2O3 | 20.0 | 23.0 | 16.0 | 22.0 | 24.0 | 20.5 | 16.0 | 24.3 | 24.0 | 23.0 |
| | CaO | 24.0 | 32.0 | 31.0 | 30.0 | 29.0 | 20.5 | 26.0 | 19.4 | 21.0 | 19.0 |
| | BaO | 0 | 0 | 1.5 | 0 | 0 | 1.5 | 1.9 | 1.9 | 1.0 | 0 |
| | Y2O3 | 0 | 0 | 0.5 | 0 | 0 | 0.5 | 0.8 | 0.7 | 0 | 0 |
| | Nb2O5 | 0 | 0 | 0 | 0 | 0 | 0 | 0 | 0 | 0 | 4.0 |
| | Na2O | 4.0 | 0 | 4.0 | 2.0 | 0 | 4.0 | 4.0 | 2.3 | 2.0 | 5.0 |
| | K2O | 7.0 | 0 | 3.5 | 1.0 | 0 | 5.0 | 7.3 | 1.0 | 2.0 | 3.0 |
| | Li2O | 6.0 | 6.0 | 6.5 | 5.0 | 6.0 | 6.0 | 6.0 | 6.4 | 7.0 | 7.0 |
| | Al2O3 | 0 | 0 | 0 | 0 | 0 | 0 | 0 | 0 | 0 | 2.5 |
| | Sb2O3 | 0 | 0 | 0 | 0 | 0 | 0 | 0 | 0 | 0 | 0.5 |

| | | | | | | | | | | |
|---|---|---|---|---|---|---|---|---|---|---|
| Index of refraction (nd) | 1.583 | 1.612 | 1.602 | 1.604 | 1.607 | 1.582 | 1.592 | 1.587 | 1.588 | 1.596 |
| Abbe number (ν d) | 58.7 | 59.7 | 56.8 | 59.7 | 60.3 | 60.1 | 56.9 | 61.5 | 61.0 | 56.4 |
| Specific gravity (g/cm3) | 2.66 | 2.74 | 2.71 | 2.73 | 2.71 | 2.68 | 2.72 | 2.67 | 2.67 | 2.72 |
| Glass transition | 485 | 548 | 472 | 540 | 550 | 491 | 460 | 526 | 516 | 493 |
| temperature (Tg) | | | | | | | | | | |

1. Optical glass for press molding comprising 35 to 45% by weight of SiO₂, 15 to 30% by weight of B₂O₃, and 18 to 33% by weight of CaO so that the total amount is 75 to 96% by weight, the optical glass having an index of refraction (nd) of 1.55 to 1.63, an optical constant value ranging from 55 to 63 by the Abbe number (νd), a specific gravity of not more than 2.75, and a glass transition temperature (Tg) of not more than 550° C.

2. The optical glass for press molding according to claim 1, further comprising 0 to 2.0% by weight of BaO, 0 to 1.0% by weight of Y₂O₃, 0 to 8.0% by weight of Na₂O, 0 to 8.0% by weight of K₂O, 4.0 to 7.5% by weight of Li₂O, 0 to 3.0% by weight of Al₂O₃, 0 to 1.0% by weight of Sb₂O₃, and 0 to 5.0% by weight of Nb₂O₅,
wherein the total amount of Na₂O, K₂O and Li₂O is not more than 18% by weight.

3. The optical glass for press molding according to claim 1, wherein the glass substantially excludes glass components other than SiO₂, B₂O₃, CaO, BaO, Y₂O₃, Na₂O, K₂O, Li₂O, Al₂O₃, Sb₂O₃, and Nb₂O₅.

4. An optical element comprising the optical glass according to claim 1.

5. The optical glass for press molding according to claim 2, wherein the glass substantially excludes glass components other than SiO₂, B₂O₃, CaO, BaO, Y₂O₃, Na₂O, K₂O, Li₂O, Al₂O₃, Sb₂O₃, and Nb₂O₅.

6. An optical element comprising the optical glass according to claim 2.
